(19) United States
(12) Patent Application Publication
(10) Pub. No.: US 2003/0147321 A1
(43) Pub. Date: Aug. 7, 2003

(54) Recording power adjusting method and optical information record apparatus using the same

(75) Inventors: Shuichi Okubo, Tokyo (JP); Minoru Akiyama, Tokyo (JP)

Correspondence Address: YOUNG & THOMPSON, 745 SOUTH 23RD STREET 2ND FLOOR, ARLINGTON, VA, 22202

(73) Assignee: NEC CORPORATION, TOKYO (JP)

(21) Appl. No.: 10/334,792

(22) Filed: Jan. 2, 2003

Related U.S. Application Data
(63) Continuation-in-part of application No. 10/272,827, filed on Oct. 18, 2002.

(30) Foreign Application Priority Data
Oct. 30, 2001 (JP) 332788/2001

(51) Int. Cl. G11B 7/125

(52) U.S. Cl. 369/47.53

(57) ABSTRACT

A signal of a test pattern is recorded on a center track among three adjacent tracks placed in a test region while changing recording power, and a signal of a test pattern is recorded on tracks adjacent to both sides while changing the recording power with the same timing. The center track is reproduced to measure reproduction signal characteristics, and the optimum recording power is adjusted based on the reproduction signal characteristics. As a result of this, the optimum recording power considering an influence of cross erasing effect can be adjusted, and the recording power can be adjusted efficiently under a high-density recording condition, particularly a narrow track pitch condition.

### BACKGROUND OF THE INVENTION

1. Field of the Invention

The present invention relates to a method for adjusting recording power of a light source such as a semiconductor laser to record information on an optical information record medium with the optimum recording power, and relates to an optical information record apparatus using the method.

2. Description of Related Art

Generally, a write once read many type medium such as CD-R or DVD-R, a magneto-optical disk, a phase change optical disk such as CD-RW, DVD-RAM or DVD-RW have been known as an optical information record medium for recording and reproducing information by the application of a laser beam. These media are all recorded by a thermal recording method using a temperature increase of the medium caused by the laser beam. Therefore, it is necessary for signal quality to accurately control a temperature of the medium on the occasion of laser application.

To control a temperature of the medium, when environmental temperature increases, laser power for recording must properly be reduced accordingly. In order to control the recording power according to a change in environment temperature, generally, a recording power adjustment region on the recordable medium is separately provided to perform trial writing, and optimization of the recording power is performed under such a condition, for example, jitter of the reproduction signal becomes minimum.

In a conventional recording power adjusting method, generally, recording power is adjusted by making recording on a center track. However, when a track pitch becomes narrow in order to enlarge recording capacity, the optimum recording power for the self-track exerts an undesirable influence for adjacent tracks. This is because a cross erasing, which accidentally erases data of adjacent tracks, occurs frequently in a rewritable optical disk.

As an optimizaion method of recording power in consideration of the cross erasing, a method which records adjacent tracks as well as a self-track has been proposed in, for example, Japanese Published Patent Application No. 11-25491. However, in this technique, since the predetermined recording power should be changed again before recording on the tracks of the disk, it takes a long time to convert predetermined power into a recording power.

Specifically, when recording power is changed into several levels, it is necessary to record and reproduce signals in each level respectively to calculate an error rate. This procedure is also required to be continued until the error rate turns smaller than a threshold. In addition, another calculation is required to determine a recording power after the calculation of the error rate. As a result, it takes a long time to determine a recording power.

Furthermore, since crystallization of a record amorphous mark causes the cross erasing in the phase change optical disk, as the number of recordings increases, crystallization proceeds and the influence of the cross erasing becomes large.

Given the influence of the cross erasing becomes large on a phase change optical disk, it is difficult to exactly estimate an influence of the cross erasing by using this method which records test signals on the adjacent tracks only one time.

### SUMMARY OF THE INVENTION

The present invention is implemented in view of the conventional problems, and an object of the invention is to provide a recording power adjusting method capable of efficiently adjusting recording power in a short time even in the case that track pitch of a record medium becomes narrow and even in the case of a phase change record medium, which is vulnerable to cross erasing. Another object of the invention is to provide an optical information record apparatus using above-mentioned method.

In order to achieve the above object, there is provided a recording power adjusting method for adjusting recording power of a light source when recording information on an optical information record medium by irradiating a light beam from the light source, comprising the steps of: recording a test pattern signal on a center track of adjacent three tracks of the optical information record medium while changing the recording power; recording the test pattern signal on each of tracks adjacent to both sides of the center track in substantial alignment on a scan line with a region of the center track where the test pattern signal is recorded while changing the recording power; reproducing the test pattern signal recorded on the center track to measure characteristics of the reproduced signal; and adjusting the recording power of the light source based on the measured characteristics of the reproduced signal.

Furthermore, in order to achieve the above object, there is provided a recording power adjusting method for adjusting recording power of a light source when recording information on an optical information record medium by irradiating a light beam from the light source, wherein the optical information record medium is provided with a plurality of test regions each having a set of a center track and tracks adjacent to both sides of the center track, comprising the steps of: recording test pattern signals on the center track once and on the adjacent tracks more than once while changing the recording power with respect to each test region; reproducing the test pattern signal recorded on the center track to measure characteristics of the reproduced signal with respect to each test region; and adjusting the recording power of the light source based on the characteristics of the reproduced signal measured with respect to each test region.

Furthermore, in order to achieve the above object, there is provided an optical information record apparatus for recording information on an optical information record medium by irradiating a light beam from a light source, comprising: a means of recording a test pattern signal on a center track of adjacent three tracks of the optical information record medium while changing the recording power; a means of recording the test pattern signal on each of tracks adjacent to both sides of the center track while changing the recording power in substantially timing with a change in the recording power for recording on the center track; a means of reproducing the test pattern signal recorded on the center track to measure characteristics of the reproduced signal; and a means of adjusting the recording power of the light source based on the measured characteristics of the reproduced signal.

### BRIEF DESCRIPTION OF THE DRAWINGS

The above and other objects, features and advantageous of the present invention will become more apparent from the following detailed description when taken in conjunction with the accompanying drawings therein:

FIG. 1 is a block diagram showing an embodiment of an optical information record apparatus of the present invention.

FIG. 2 is a flowchart showing an embodiment of a recording power adjusting method of the present invention.

FIG. 3(a) is a diagram showing an example of a record mark recorded on tracks of a test region in an adjusting process of the recording power adjusting method of FIG. 2.

FIG. 3(b) is a diagram showing an example of a record mark recorded on tracks of a test region in an adjusting process of the recording power adjusting method of FIG. 2.

FIG. 4 is a diagram describing an example of the case of starting recording on tracks of a test region using prepits formed in an optical disk.

FIG. 5 is a diagram describing an example of the case of starting recording on tracks of a test region at the time when prepits formed in an optical disk deviate among adjacent tracks.

FIG. 6 is a diagram describing the overlap of the record marks on a center track and adjacent tracks.

FIG. 7 is a diagram describing the recording of a signal on tracks of a test region in a first embodiment of the present invention.

FIG. 8 is the graph illustrating the jitter measured in the center track of the case of recording on only the center track.

FIG. 9 is the graph illustrating the jitter measured in the center track of the case of recording once, twice and five times on the adjacent tracks.

FIG. 10 is a diagram describing the recording of a signal on tracks of a test region in a second embodiment of the present invention.

### DETAILED DESCRIPTION OF THE PREFERRED EMBODIMENTS

The present invention will now be described in detail below with reference to the accompanying drawings.

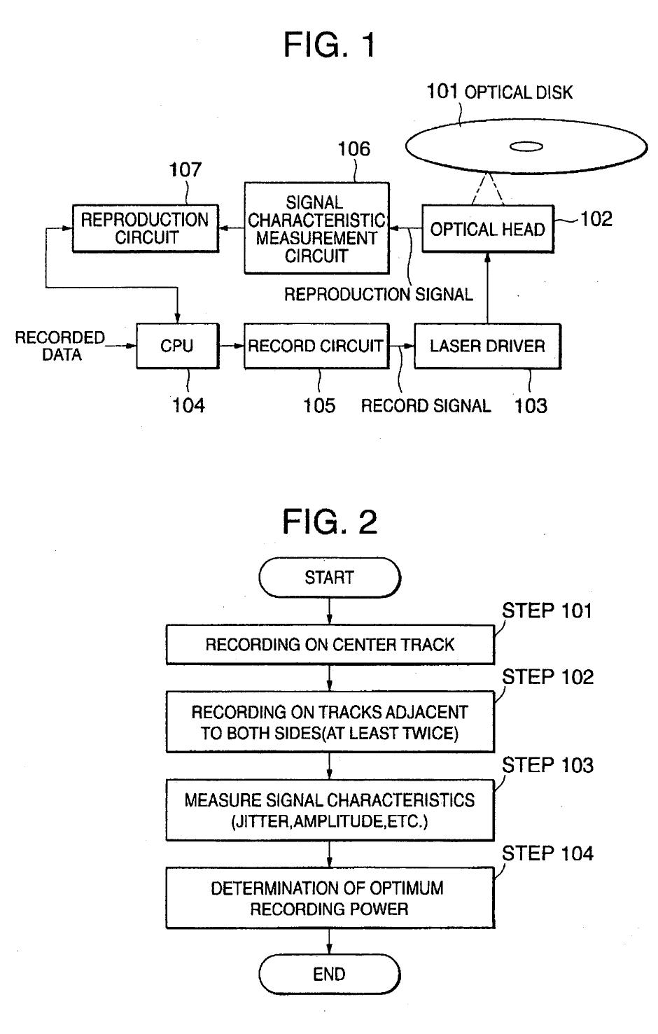

FIG. 1 is a block diagram showing a configuration of one embodiment of an optical information record apparatus of the present invention. In FIG. 1, numeral 101 is an optical disk or an information record medium. In the present embodiment, a phase change optical disk is described as the optical disk 101, but the present invention can be applied to a magneto-optical disk etc.

Numeral 102 is an optical head for recording and reproducing information on the optical disk 101. Various optical elements such as a semiconductor laser (not shown) which is a light source for recording and reproducing, an objective lens (not shown) for gathering a light beam emitted from the semiconductor laser on the optical disk 101, an optical sensor (not shown) for detecting reflected light from the optical disk 101, etc. are provided inside the optical head 102.

Numeral 103 is a laser driver for driving the laser inside the optical head 102, and numeral 104 is a CPU for controlling the whole apparatus, and numeral 105 is a record circuit for processing recorded data from the CPU 104 and supplying the data to the laser driver 103 as a record signal. Numeral 106 is a signal characteristic measurement circuit for measuring signal characteristics of a reproduction signal from the optical head 102, and numeral 107 is a reproduction circuit for performing predetermined signal processing using the reproduction signal from the optical head 102 and producing reproduced data.

As described below in detail, the signal characteristic measurement circuit 106 measures, e.g., amplitude and jitter of the reproduction signal before adjusting recording power, and the CPU 104 adjusts the optimum recording power of the semiconductor laser based on its measured result. An adjusting method of the optimum recording power will be described below in detail with reference to the drawings. The CPU 104 performs centralized control (such as record timing control, reproduction timing control) inside the apparatus in addition to power setting of the semiconductor laser inside the optical head 102, and records or reproduces data on the optical disk 101.

A recording power adjusting method of the present embodiment will be described. FIG. 2 is a flowchart showing an embodiment of the recording power adjusting method of the present invention. As is shown in FIG. 2, when the optical disk 101 is inserted into the apparatus, the CPU 104 moves the optical head 102 to a test region of the optical disk 101 and supplies preset recorded data to the record circuit 105. Then, the CPU 104 records a signal of a preset predetermined pattern on a center track T0 located in the center among three adjacent tracks of the test region while changing recording power (step 101).

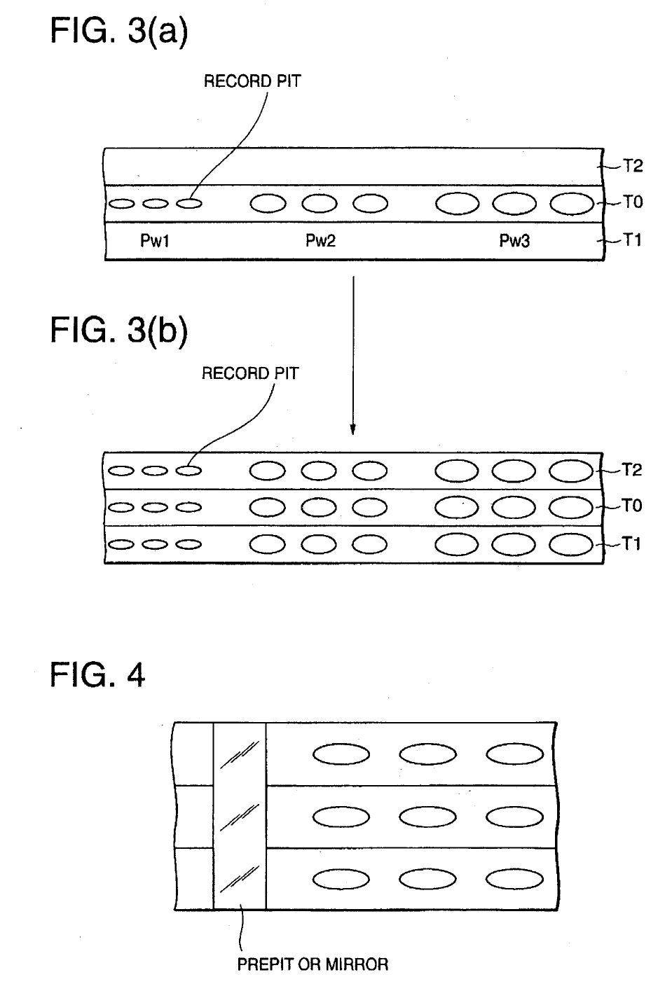

FIG. 3(a) shows an example of a record mark recorded at this time. T0 is a center track of the test region, and T1 and T2 are tracks adjacent to both sides of the center track T0. In the present embodiment, a predetermined pattern is recorded on the center track T0 while changing recording power as indicated by Pw1, Pw2, Pw3. As shown in FIG. 3(a), sizes of record pits change in proportion to the recording power.

When recording on the center track T0 is completed, as shown in FIG. 3(b), a signal of a predetermined pattern is respectively recorded on the tracks T1, T2 adjacent to both sides of the center track while changing the recording power (step 102). As shown in FIG. 3(b), the signal is recorded while changing the recording power with the same timing as that of the center track T0. As to recording on the adjacent tracks T1, T2, it is desirable to make recordings at least twice as described below in detail.

When a guide groove is spirally formed in the optical disk 101, one full circle corresponds to one track. In the present embodiment, recording is performed on the same record track by different recording power, for the purpose of reducing a test region.

To align the recording patterns (individual record pits) of the center track T0 with those of the adjacent tracks T1, T2, prepits can be used. (Prepits are previously formed on an optical disk substrate.) For example, as shown in FIG. 4, by adjusting start timing of recording for each track with reference to prepits (or a mirror in which a guide groove is not formed), the timing of a change in the recording power becomes aligned on three tracks of the test region.

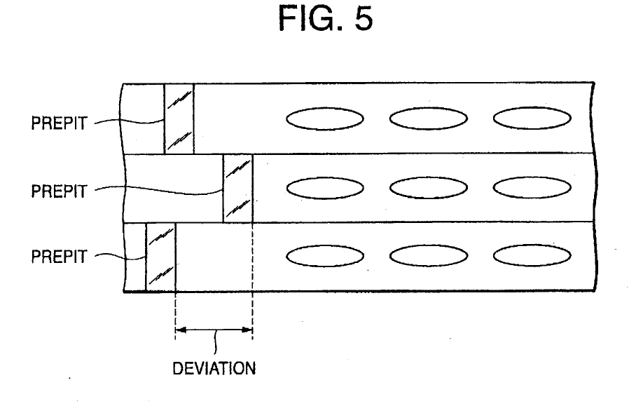

Since a prepit of address information etc. is generally formed previously for an optical disk, timing of recording can be adjusted using this prepit. However, prepits are not necessarily present adjacently on adjacent tracks and as shown in FIG. 5, there is a case that the prepits are placed in a deviation state. In that case, as shown in FIG. 5, the amount of deviation of a distance between adjacent prepits is previously calculated and based on the amount, timing of a recording may be adjusted.

When recording of the tracks T1, T2 adjacent to both sides is completed, the CPU 104 controls the laser driver 103 to reproduce the signal of the center track T0 using a semiconductor laser inside the optical head 102 as reproduction power. A reproduction signal outputted from the optical head 102 is inputted to the signal characteristic measurement circuit 106. In the signal characteristic measurement circuit 106, amplitude of the reproduction signal is measured in response to a change in the recording power and is outputted to the CPU 104 (step 103).

In the CPU 104, recording power and signal amplitude are associated and are stored in memory (not shown) and based on it, the recording power at the time when the reproduction signal amplitude becomes maximum is determined as the optimum recording power (step 104). The CPU 104 controls the laser driver 103 to adjust the recording power of the semiconductor laser inside the optical head 102 to the determined recording power. Subsequently, information is recorded on the optical disk 101 by this optimum recording power. Incidentally, the adjusting operation, which is done at the time of inserting the optical disk 101, has been described, but it is not limited to this example. The adjustment may be made periodically at the time of operation of the optical information record apparatus.

A repeated pattern of a single pattern (for example, nT pattern: T is a window width, n is an integer of 1 to 16, or repeat of kT mark, lT space, mT mark and nT space: k, l, m, n are integers of 1 to 16) or random data is recorded on the center track T0 shown in FIG. 3 and similarly, a signal of the same pattern as that of the center track T0 may be recorded on the tracks T1, T2 adjacent to both sides. Thereafter, the center track T0 is reproduced and the recording power at the time when reproduction signal amplitude becomes maximum is determined as the optimum recording power.

By the signal characteristic measurement circuit 106, jitter of a reproduction signal may be measured to determine recording power in which the jitter becomes minimum as the optimum recording power. Further, there are other methods instead of measuring of the jitter to determine the optimum recording power. For example, after being converted from the reproduction signal to digital signal, the digital signal is used to measure deviation time between a rise position and a fall position of the pulse and a reference clock. The number of deviation which is longer than the reference time (window width) determined by the reference clock is counted. When this number comes to be the smallest, the recording power is the optimum.

In any case, random data (there is no need to be the same data as that of the center track) or a repeated pattern of a single pattern may be recorded on the tracks T1, T2 adjacent to both sides in a same manner to the center track T0. Recording of the random data is similar to the actual use. In order to make an influence of adjacent recording more remarkable, it is preferable to use a combination (for example, 8T mark, 2T space, 2T mark, 2T space) of an integer of 7 or more and an integer of 3 or less as combinations of k, l, m, n. This is because an influence of crosstalk can be made remarkable by the long mark (7T or more) and an influence of cross erasing can be made remarkable by the short mark (3T or less).

Since the cross erasing is a phenomenon by thermal accumulation, the influence of the cross erasing becomes remarkable as the number of rewritings of the adjacent tracks increases. Therefore, it is desirable to make recording on the adjacent tracks at least twice at the time of adjusting recording power. Actually, rewritings of over one hundred times of only the adjacent tracks seldom occurs and it takes a long time to adjust recording power too many times, so that it is sufficient in the case of making recording about fifty times at the maximum.

Incidentally, it is unnecessary to use all the tracks of a test region in a recording power adjustment. It is sufficient to use tracks in sector units or sync frame units. The cases of measuring jitter of a reproduction signal of the center track after cross erasing and determining the optimum recording power condition will be considered as below.

In this case, when a sector length is 2 KBytes, data of 16000 bits can be recorded on one sector, so that about 4000 bits data can be recorded as a certain power if recording power is changed in four ways. According to experiment by the inventor of the present application, it is verified that 1,000 bits are enough to adjust recording power, and it is possible to change the recording power within one sector to make recording and determine the optimum recording power condition.

Within the same sector, recording may be done by the same recording power, and when the sector changes, the recording power may be change. But it is preferable to change the recording power within the same sector because a region which users can use will not reduce.

In the present example, the recording power is adjusted using three adjacent tracks, so that the three tracks are handled as one unit in placement control of a test region. When the three tracks are used as one unit thus, a region shifted by one to three tracks is used as a new test region after making recording. However, since there is a difference between the sensitivity of a track which is recorded and the sensitivity of a track which is not yet recorded. It is preferable to be shifted by three tracks and adjust the recording power. In this case, the number of tracks allocated as a test region is integral multiple of three.

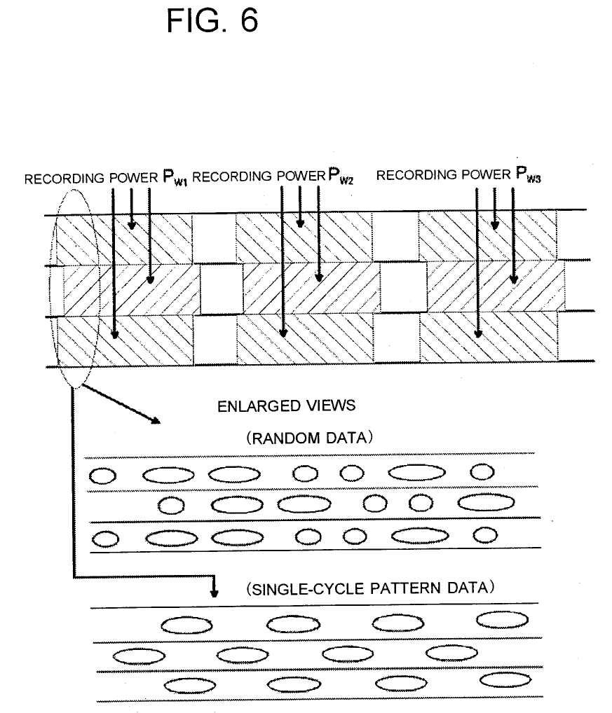

Incidentally, it is preferable that the recording power is changed in the same timing on the center track and tracks adjacent thereto. In other words, the center track and adjacent tracks are preferably equal in the recording power. This is because the phenomenon of cross erasing occurs on the occasion of recording on the adjacent tracks resulting from the crystallization of a mark previously recorded on the center track. The influence of the cross erasing becomes most remarkable in the case where the recording power is applied to the adjacent tracks, which increases the temperature in the center track to its peak, when the record mark exists on the center track. However, some difference in recording power change timing between the center track and adjacent tracks (for example, a deviation of 8T: the longest data length in (1-7) modulation recording) dose not create a serious problem. FIG. 6 is a diagram showing the recording power change timing on the adjacent three tracks. In FIG. 6, shaded portions indicate regions where recording is executed with the recording power Pw1, Pw2 and Pw3 on the respective tracks. Incidentally, the recording power is constant at Pw1, Pw2 or Pw3 in each shaded regions. In FIG. 6, as can be seen from enlarged views, there are differences in record start positions (recording power change timing) between the center track and adjacent tracks. Nevertheless, the record mark exists in the region of the respective tracks adjacent to the record mark existing region of the center track. Namely, the record mark existing region in the center track corresponds to the regions of the respective adjacent tracks to which the recording power applied). In this case, it is possible to find out the quantitative effect of the cross erasing. While the cross erasing does not occur at the end of each shaded region on the center track since the recording power is not being applied to the adjacent tracks, more than 1000 bits are used to define the data for the recording power adjustment and, therefore, if the data of 8T (=8 bits) is not affected by the cross erasing, there is little effect on the result of the adjustment. However, in the case of recording on both the center track and adjacent track by repeating a single-cycle data pattern (for example, repetition of 8T mark and 8T space), it is necessary to control the recording power change timing accurately. This is because a recording of single-cycle data has a possibility that no record mark exists on the center track when applying the recording power to the adjacent tracks. As a result, the effect of the cross erasing cannot be measured since the cross erasing occurs on condition that the recording power is applied to the adjacent tracks, which creates a largest increase in temperature in the center track, when the record mark exists on the center track. In order to measure the effect of the cross erasing, it is preferable that the recording power is applied to a region in the respective adjacent tracks, which overlaps with more than half of the record mark existing region on the center track. Consequently, it is required to control the record start positions or recording power change timing with 4T degrees of accuracy when performing the recording power adjustment on the basis of the 8T mark/8T space repeat pattern.

The inventor of the present application made an optical disk and adjusted recording power using its optical disk. This will be described below as first and second embodiments.

(First Embodiment)

In a first embodiment, 100 nm of Al layer, 20 nm of ZnS—SiO₂ layer, 13 nm of GeSbTe layer and 50 nm of ZnS—SiO₂ layer were sequentially formed on a polycarbonate substrate with a thickness of 1.2 mm by sputtering. Further, 0.1 mm of an ultraviolet cure resin layer is formed thereon. In a guide groove formed in the polycarbonate substrate, a groove depth is 40 nm and a pitch was 0.3 μm.

This disk is rotated at a line speed of 5 m/s and using an optical head with a wavelength of 405 nm and an objective lens of NA=0.85. The laser beam is irradiated from the side of the ultraviolet cure resin layer, and recording and reproducing are made to adjust the recording power.

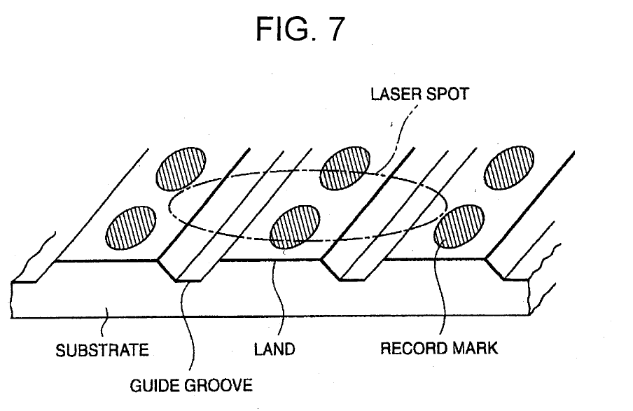

Data of 2000 bits are recorded on a center track T0 of the optical disk with the recording power changing from 3.2 to 3.4, 3.6, 3.8 and 4.0 mW. A clock frequency is 60 MHz. As shown in FIG. 7, recording is made on only a portion between the guide grooves (land). Thereafter, the recording is made on tracks T1, T2 adjacent to both sides of the center track T0 while changing the recording power in a same manner to the center track T0. Then, the center track T0 is reproduced and jitter of a reproduction signal is measured.

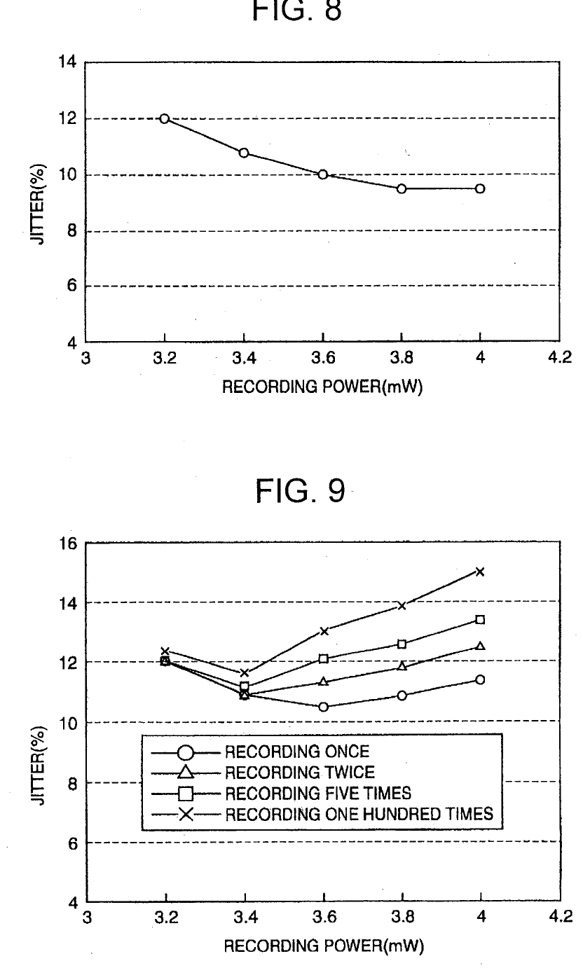

FIG. 8 is the graph illustrating the jitter measured in the center track T0 of the case of recording on only the center track T0. The jitter indicates a lowest value in the recording power of 3.8 mW or more. FIG. 9 is the graph illustrating the jitter measured in the center track T0 of the case of recording once, twice and five times on the adjacent tracks T1, T2.

As is shown in FIG. 9, in the case of recording on the adjacent tracks T1, T2 only once, the jitter becomes minimum in the recording power of 3.6 mW and this is found to be the optimum recording power. On the other hand, in the case of making the recording on the adjacent tracks T1, T2 at least twice, the optimum recording power is 3.4 mW. That is, in the case of recording on the adjacent tracks at least twice, the optimum recording power reduces by 0.2 mW and it represents the effect of the cross erasing.

Therefore, if the cross erasing is taken into consideration, the optimum recording power is 3.4 mW. Incidentally, FIG. 9 shows the jitter of the case of recording on the adjacent tracks one hundred times. Under an influence of the cross erasing, a jitter becomes bigger in proportion to recording times, but the optimum recording power itself does not vary.

(Second Example)

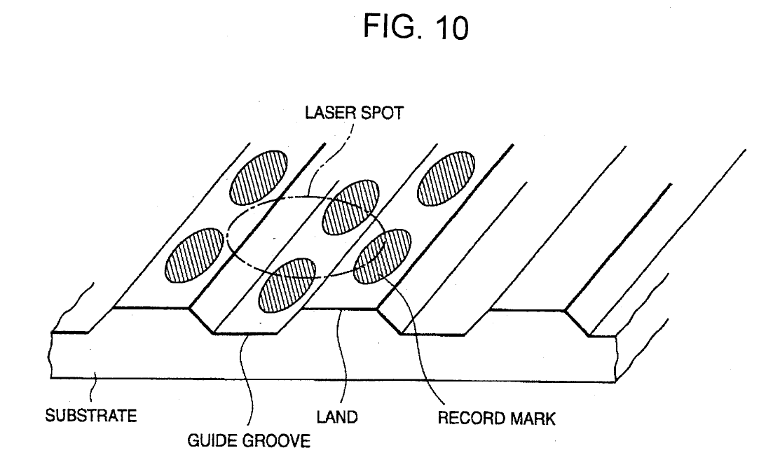

As shown in FIG. 10, a difference between the second embodiment and the first embodiment resides in a pitch of a groove (0.6 μm), and in a portion to which laser beam is input. Recording is made on both of a guide groove portion (groove) and a portion between the guide grooves (land).

This disk is rotated at a line speed of 5 m/s and using an optical head with a wavelength of 405 nm and an objective lens of NA=0.85. The laser beam is input to the side of the ultraviolet cure resin layer, and recording and reproducing are made to adjust the recording power.

Data of 1000 bits are recorded on a land of the optical disk with the recording power changing from 3.2 to 3.4, 3.6, 3.8 and 4.0 mW. A clock frequency is 60 MHz, similar to the first embodiment. Thereafter, the recordings are respectively made on grooves of both sides adjacent to this land changing the recording power in a same manner to the land. Then, the land portion is reproduced and jitter of a reproduction signal is measured. Similar to the first example, while the optimum recording power in the case of recording once on both adjacent tracks is 3.6 mW, the optimum recording power in the case of recording at least twice on the adjacent tracks is 3.4 mW.

The land is susceptible to an influence of cross erasing, so that the land is set as the center track. In this embodiment, the laser beam is irradiated from the side of the ultraviolet cure resin layer. Contrary to this, in the case that the laser beam is input to the side of a substrate, which is the case of DVD-RAM etc., since the cross erase effect exerts more influence on the guide groove than the land, the recording on the groove is made before the recording on the lands.

Incidentally, in the above-mentioned embodiment, the case that the recording power is changed within one track and a signal of a predetermined pattern is recorded on the center track and the adjacent tracks of both sides, has been described, but the present invention is not limited to this and the recording power may be changed within every track. Specifically, plural test regions in which three tracks of a center track and two adjacent tracks are used as one set are placed and a predetermined pattern is recorded on a center track of one of the test regions and a predetermined pattern is recorded on the adjacent tracks by the same recording power as that of the center track.

Then, a predetermined pattern is recorded on a center track of another test region while changing the recording power from the previous time, and a predetermined pattern is recorded on the adjacent tracks by the same recording power as that of the center track. Subsequently, a predetermined pattern is recorded on a center track and the adjacent tracks while changing the recording power in every test region. Thereafter, the center track of each test region is reproduced to measure reproduction signal characteristics and based on it, the optimum recording power is adjusted.

The predetermined pattern recorded on the center track of each the test region and the adjacent tracks of both sides, or a measurement method of the signal characteristics (reproduction signal amplitude or jitter) of the reproduction signal every test region is similar to the second embodiment. A determination of the optimum recording power is made in a same manner to the second embodiment.

The optimum recording power can be determined by the maximum amplitudes of the reproduction signal, or by the minimum jitter of the reproduction signal. It is preferable to record the signal at least twice on the adjacent tracks. In such a method, additionally mentioned above, the optimum recording power, considering cross erasing, can be determined.

According to the present invention, even in the case that tracks of a record medium become narrow, the optimum recording power considering an influence of cross erasing can be determined efficiently in a short time, and high-density recording with high reliability can be achieved. Since test recording is made changing the recording power within one track, the recording power can be determined in a small test region and a region for recording can be ensured sufficiently. Further, by making recording on tracks adjacent to both sides of a center track at least twice, it can be used preferably in a recording power adjustment of a phase change record medium.

While this invention has been described in connection with certain preferred embodiments, it is to be understood that the subject matter encompassed be way of this invention is not to be limited to those specific embodiments. On the contrary, it is intended for the subject matter of the invention to include all alternative, modification and equivalents as can be included within the spirit and scope of the following claims.

What is claimed is:

1. A recording power adjusting method for adjusting recording power of a light source when recording information on an optical information record medium by irradiating a light beam from the light source, comprising the steps of:
recording a test pattern signal on a center track of adjacent three tracks of the optical information record medium while changing the recording power;
recording the test pattern signal on each of tracks adjacent to both sides of the center track in substantial alignment on a scan line with a region of the center track where the test pattern signal is recorded while changing the recording power;
reproducing the test pattern signal recorded on the center track to measure characteristics of the reproduced signal; and
adjusting the recording power of the light source based on the measured characteristics of the reproduced signal.

2. The recording power adjusting method claimed in claim 1, wherein the test pattern signal is recorded on each of the tracks adjacent to both sides of the center track more than once.

3. The recording power adjusting method claimed in claim 1, wherein the test pattern signals are recorded on the respective three tracks so as to be substantially equal in data length on a scan line of the optical information record medium.

4. The recording power adjusting method claimed in claim 2, wherein the test pattern signals are recorded on the respective three tracks so as to be substantially equal in data length on a scan line of the optical information record medium.

5. The recording power adjusting method claimed in claim 1, wherein the test pattern signals are recorded on the respective three tracks while changing the recording power with substantially the same timing on a scan line of the optical information record medium.

6. The recording power adjusting method claimed in claim 2, wherein the test pattern signals are recorded on the respective three tracks while changing the recording power with substantially the same timing on a scan line of the optical information record medium.

7. The recording power adjusting method claimed in claim 1, further comprising the steps of:
measuring amplitude of the reproduced signal on the center track; and
determining the recording power based on the signal amplitude.

8. The recording power adjusting method claimed in claim 2, further comprising the steps of:
measuring amplitude of the reproduced signal on the center track; and
determining the recording power based on the signal amplitude.

9. The recording power adjusting method claimed in claim 1, further comprising the steps of:
measuring jitter of the reproduced signal on the center track; and
adjusting the recording power based on the jitter.

10. The recording power adjusting method claimed in claim 2, further comprising the steps of:
measuring jitter of the reproduced signal on the center track; and
adjusting the recording power based on the jitter.

11. The recording power adjusting method claimed in claim 1, wherein:
the test pattern signal recorded on the center track is a random data signal; and
the test pattern signals recorded on the adjacent tracks are at least one of random pattern and cycle repeat pattern signals.

12. The recording power adjusting method claimed in claim 2, wherein:
the test pattern signal recorded on the center track is a random data signal; and
the test pattern signals recorded on the adjacent tracks are at least one of random pattern and cycle repeat pattern signals.

13. The recording power adjusting method claimed in claim 1, wherein:
the test pattern signal recorded on the center track is a cycle repeat pattern signal; and
the test pattern signals recorded on the adjacent tracks are at least one of random pattern and cycle repeat pattern signals.

14. The recording power adjusting method claimed in claim 2, wherein:
the test pattern signal recorded on the center track is a cycle repeat pattern signal; and
the test pattern signals recorded on the adjacent tracks are at least one of random pattern and cycle repeat pattern signals.

15. The recording power adjusting method claimed in claim 1, wherein tracks of an integral multiple of three are placed in the optical information record medium as test regions for adjusting the recording power.

16. The recording power adjusting method claimed in claim 2, wherein tracks of an integral multiple of three are placed in the optical information record medium as test regions for adjusting the recording power.

17. The recording power adjusting method claimed in claim 1, wherein a plurality of prepits are formed in the optical information record medium, and the test pattern signals are recorded on the three tracks with the use of the prepits while changing the recording power with substantially the same timing on a scan line of the optical information record medium, further comprising the steps of:
calculating previously, when there are deviations in positions of the prepits on the adjacent tracks, the amount of the deviations; and
adjusting the timing of changes in the recording power for recording the test pattern signals on the three tracks in the test region based on the amount.

18. The recording power adjusting method claimed in claim 2, wherein:
a plurality of prepits are formed in the optical information record medium;
tracks of an integral multiple of three are placed in the optical information record medium as test regions for adjusting the recording power; and
the test pattern signals are recorded on the three tracks with the use of the prepits while changing the recording power with substantially the same timing on a scan line of the optical information record medium; further comprising the steps of:
calculating previously, when there are deviations in positions of the prepits on the adjacent tracks, the amount of the deviations; and
adjusting the timing of changes in the recording power for recording the test pattern signals on the three tracks in the test region based on the amount.

19. The recording power adjusting method claimed in claim 1, wherein the record medium is a phase change record medium.

20. The recording power adjusting method claimed in claim 2, wherein the record medium is a phase change record medium.

21. A recording power adjusting method for adjusting recording power of a light source when recording information on an optical information record medium by irradiating a light beam from the light source, wherein the optical information record medium is provided with a plurality of test regions including a set of a center track and tracks adjacent to both sides of the center track, comprising the steps of:
recording test pattern signals on the center track once and on the adjacent tracks more than once while changing the recording power with respect to each test region;
reproducing the test pattern signal recorded on the center track to measure characteristics of the reproduced signal with respect to each test region; and
adjusting the recording power of the light source based on the characteristics of the reproduced signal measured with respect to each test region.

22. An optical information record apparatus for recording information on an optical information record medium by irradiating a light beam from a light source, comprising:
a means of recording a test pattern signal on a center track of adjacent three tracks of the optical information record medium while changing the recording power;
a means of recording the test pattern signal on each of tracks adjacent to both sides of the center track in a region in substantial alignment with a region of the center track where the test pattern signal is recorded on a scan line while changing the recording power;
a means of reproducing the test pattern signal recorded on the center track to measure characteristics of the reproduced signal; and
a means of adjusting the recording power of the light source based on the measured characteristics of the reproduced signal.
